(19) United States
(12) Patent Application Publication
(10) Pub. No.: US 2025/0256941 A1
(43) Pub. Date: Aug. 14, 2025

(54) CONTROLLING AN ENERGY SAVING MODE OF AN ELEVATOR

(71) Applicant: KONE Corporation, Helsinki (FI)

(72) Inventors: Tuukka Kauppinen, Helsinki (FI); Ari Pikivirta, Helsinki (FI)

(73) Assignee: KONE Corporation, Helsinki (FI)

(21) Appl. No.: 18/986,378

(22) Filed: Dec. 18, 2024

(30) Foreign Application Priority Data
Jan. 19, 2024 (EP) 24152823.1

(51) Int. Cl. B66B 1/30

(52) U.S. Cl. CPC B66B 1/302; B66B 2201/216

(57) ABSTRACT

A controller for controlling an energy saving mode of an elevator includes at least one processor and at least one memory storing instructions that, when executed by the at least one processor, cause the controller to at least perform: obtaining information associated with operating the elevator; determining dynamically a time period for maintaining an idle mode of the elevator based at least in part on the information; and issuing a request to switch from the idle mode to the energy saving mode after the time period expires.

### TECHNICAL FIELD

Various examples generally relate to the field of elevator systems. In particular, some examples relate to a solution for controlling an energy saving mode of an elevator.

### BACKGROUND

An elevator has plurality of components, which consume energy during operation of the elevator. In addition to this, the energy consumption of the elevator may be relatively high even during intermediate periods, when the elevator is idle. One possible solution for entering an energy saving mode is that the power supply to specified elevator components may be interrupted after a fixed time delay from the most recent observed event, such as from a landing call signal or a speed signal of elevator car. However, as already mentioned above, the energy consumption of the elevator may be relatively high during the fixed time delay. Another challenge with the fixed time delay is how to choose the fixed time delay while taking into account the energy consumption of the elevator during the fixed time delay.

Further, some elevator components, for example, a contactor, may have mechanical parts that wear when they are opened and closed. In view of their lifetime, it would be desirable to limit the amount of unnecessary switching operations in order to extend the lifetime of the components. However, at the same time, if these parts are constantly kept in the idle mode, energy consumption may still be relatively high even during the idle mode.

### SUMMARY

The scope of protection sought for various example embodiments of the disclosure is set out by the independent claims. The example embodiments and features, if any, described in this specification that do not fall under the scope of the independent claims are to be interpreted as examples useful for understanding various example embodiments of the disclosure.

According to a first aspect, there is provided a controller for controlling an energy saving mode of an elevator. The controller comprises at least one processor and at least one memory storing instructions that, when executed by the at least one processor, cause the elevator system apparatus to at least perform: obtaining information associated with operating the elevator; determining dynamically a time period for maintaining an idle mode of the elevator based at least in part on the information; and issuing a request to switch from the idle mode to the energy saving mode after the time period expires.

In an implementation form of the first aspect, the information associated with operating the elevator comprises at least one elevator event, and the at least one memory stores instructions that, when executed by the at least one processor, cause the controller to at least perform: identifying elevator events; and issuing the request to switch from the idle mode to the energy saving mode after the time period expires from the last elevator event.

In an implementation form of the first aspect, determining dynamically a time period for maintaining an idle mode based at least in part on the information comprises determining dynamically the time period for maintaining the idle mode based at least in part on the number of most recent elevator events per a time unit.

In an implementation form of the first aspect, determining dynamically a time period for maintaining an idle mode based at least in part on the information comprises determining dynamically the time period for maintaining the idle mode based at least in part on time between the number of most recent elevator events.

In an implementation form the first aspect, of determining dynamically a time period for maintaining an idle mode based at least in part on the information comprises determining dynamically the time period for maintaining the idle mode based at least in part on a statistical distribution of the elevator events.

In an implementation form of the first aspect, the at least one memory stores instructions that, when executed by the at least one processor, cause the controller to at least perform: increasing the time period in response to an increase in the number of the most recent elevator events per a time unit.

In an implementation form of the first aspect, the at least one memory stores instructions that, when executed by the at least one processor, cause the controller to at least perform: decreasing the time period in response to a decrease in the number of the most recent elevator events per a time unit.

In an implementation form of the first aspect, the at least one memory stores instructions that, when executed by the at least one processor, cause the controller to at least perform: increasing the time period in response to a decrease in time between the most recent elevator events.

In an implementation form of the first aspect, the at least one memory stores instructions that, when executed by the at least one processor, cause the controller to at least perform: decreasing the time delay in response to an increase in time between the most recent elevator events.

In an implementation form of the first aspect, the elevator event comprises an elevator service request issued via an input device.

In an implementation form of the first aspect, the elevator event comprises an elevator run of the elevator.

In an implementation form of the first aspect, the elevator comprises a known and/or an expected lifetime of at least one elevator component.

In an implementation form of the first aspect, the information associated with operating the elevator comprises power consumption of the elevator.

In an implementation form of the first aspect, the information associated with operating the elevator comprises a statistical elevator traffic distribution in different times of day.

In an implementation form of the first aspect, the information associated with operating the elevator comprises a cost of energy for operating the elevator.

In an implementation form of the first aspect, the controller is an elevator control unit.

In an implementation form of the first aspect, the controller is a control unit of a drive unit of an elevator hoisting motor.

According to a second aspect, there is provided a control arrangement for controlling an energy saving mode of an elevator. The control arrangement comprises a controller according to the first aspect; and a power supply switch configured to cut off the power supply of at least one elevator component in response to the request from the controller.

In an implementation form of the second aspect, the at least one elevator component comprises a drive unit of an elevator hoisting motor.

According to a third aspect, there is provided a method for controlling an energy saving mode of an elevator. The method comprises obtaining, by a controller, information associated with operating the elevator; determining, by the controller, dynamically a time period for maintaining an idle mode based at least in part on the information; and issuing, by the controller, a request to enter the energy saving mode after the time period expires.

In an implementation form of the third aspect, the information associated with operating the elevator comprises at least one elevator event, and the method further comprises identifying elevator events; and issuing the request to switch from the idle mode to the energy saving mode after the time period expires from the last elevator event.

In an implementation form of the third aspect, determining dynamically a time period for maintaining an idle mode based at least in part on the information comprises determining dynamically the time period for maintaining the idle mode based at least in part on the number of most recent elevator events per a time unit.

In an implementation form of the third aspect, determining dynamically a time period for maintaining an idle mode based at least in part on the information comprises determining dynamically the time period for maintaining the idle mode based at least in part on time between the number of most recent elevator events.

In an implementation form the third aspect, of determining dynamically a time period for maintaining an idle mode based at least in part on the information comprises determining dynamically the time period for maintaining the idle mode based at least in part on a statistical distribution of the elevator events.

In an implementation form of the third aspect, the method further comprises increasing the time period in response to an increase in the number of the most recent elevator events per a time unit.

In an implementation form of the third aspect, the method further comprises decreasing the time period in response to a decrease in the number of the most recent elevator events per a time unit.

In an implementation form of the third aspect, the method further comprises increasing the time period in response to a decrease in time between the most recent elevator events.

In an implementation form of the third aspect, the method further comprises decreasing the time delay in response to an increase in time between the most recent elevator events.

In an implementation form of the third aspect, the elevator event comprises an elevator service request issued via an input device.

In an implementation form of the third aspect, the elevator event comprises an elevator run of the elevator.

In an implementation form of the third aspect, the elevator comprises a known and/or an expected lifetime of at least one elevator component.

In an implementation form of the third aspect, the information associated with operating the elevator comprises power consumption of the elevator.

In an implementation form of the third aspect, the information associated with operating the elevator comprises a statistical elevator traffic distribution in different times of day.

In an implementation form of the third aspect, the information associated with operating the elevator comprises a cost of energy for operating the elevator.

In an implementation form of the third aspect, the controller is an elevator control unit.

In an implementation form of the third aspect, the controller is a control unit of a drive unit of an elevator hoisting motor.

According to a fourth aspect, there is provided a computer program comprising instructions which, when the program is executed by at least one processor, cause a system to perform the method of the third or fourth aspect.

According to a fifth aspect, there is provided a computer-readable medium comprising a computer program comprising instructions which, when the program is executed by at least one processor, cause a system to perform the method of the third or fourth aspect.

According to a sixth aspect, there is provided a controller for controlling an energy saving mode of an elevator. The controller comprises means for: obtaining information associated with operating the elevator; determining dynamically a time period for maintaining an idle mode based at least in part on the information; and issuing a request to enter the energy saving mode after the time period expires.

According to a seventh aspect, there is provided an elevator, which comprises a control arrangement according to the second aspect.

### BRIEF DESCRIPTION OF THE DRAWINGS

The accompanying drawings, which are included to provide a further understanding of the invention and constitute a part of this specification, illustrate examples of the invention and together with the description help to explain the principles of the invention. In the drawings:

FIG. 1 illustrates a flow diagram of a method according to an example embodiment.

FIG. 2 illustrates a block diagram of a controller for controlling an energy saving mode of an elevator according to an example embodiment.

FIG. 3 illustrates a block diagram of a control arrangement for controlling an energy saving mode of an elevator according to an example embodiment.

### DETAILED DESCRIPTION

Various examples and embodiments discussed below illustrate a solution for controlling an energy saving mode of an elevator. In the discussed solution, the time period after which the elevator is configured to enter the energy saving mode from an idle mode is determined dynamically during the operation of the elevator based on information associated with operating the elevator. In other words, the time period may change during the operation of the elevator instead of being a fixed time period.

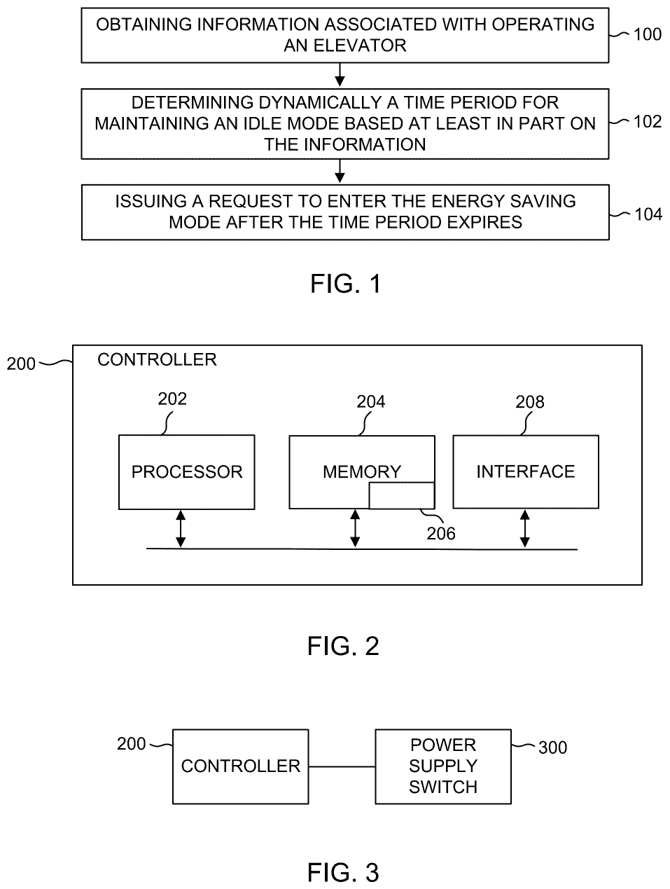

FIG. 1 illustrates a flow diagram of a method according to an example embodiment. The method may be implemented by an elevator system apparatus, for example, a controller of an elevator system. The controller may be, for example, an elevator control unit or a control unit of a drive unit of an elevator hoisting motor.

At 100, information associated with operating the elevator may be obtained. The information may characterize the operation of the elevator. For example, the information associated with operating the elevator may comprise at least one elevator event. In an example embodiment, the elevator event may comprise an elevator run of the elevator. In an example embodiment, the information associated with operating the elevator may comprise a known and/or an expected lifetime of at least one elevator component. In another example embodiment, the information associated with operating the elevator may comprise power consumption of the elevator. In another example embodiment, the information associated with operating the elevator may comprise a statistical elevator traffic distribution in different times of day. In another example embodiment, the information associated with operating the elevator may comprise a cost of energy for operating the elevator.

At 102, a time period for maintaining an idle mode of the elevator may be determined dynamically based at least in part on the information. The expression “determine dynamically” means that the time period is not fixed or hard-coded to a certain value, but can vary depending on the information characterizing the operation of the elevator. It thus means the same as “a dynamical time period”. The time period may also vary depending on the time of day. The idle mode of the elevator may refer to a mode in which the elevator is not in use but is ready for use, i.e. the elevator is not currently serving an elevator call but is ready to serve an elevator call. In the idle mode, the energy consumption of the elevator may be relatively high even though the elevator is not serving an elevator call.

At 104, a request to switch from the idle mode to the energy saving mode may be issued after the time period expires. In the energy saving mode, the power supply to an elevator component in question is not applied. In other words, in the energy saving mode, power may not be supplied to one or more elevator components.

In an example embodiment, the information associated with operating the elevator comprises at least one elevator event. An elevator event may refer, for example, to one or more most recent elevator events. For example, an elevator event may refer to one or more of the following: a landing call signal, a speed signal of the elevator car, or a signal from a light curtain, a camera or corresponding access detecting device. The controller may be configured to identify elevator events that happen in the course of time and issue the request to switch from the idle mode to the energy saving mode after the time period expires from the last elevator event. In an example embodiment, the time period may be elevator component or elevator component group specific. In other words, different elevator components may have a different associated time period for maintaining the idle mode. For example, some elevator components, such as an elevator drive unit, may take longer time to recover from the energy saving mode than some other elevator components, such as a processor board. Therefore, it may be useful if the drive unit has longer time period for maintaining the idle mode.

In an example embodiment, determining dynamically a time period for maintaining an idle mode of the elevator based at least in part on the information may comprise determining dynamically the time period for maintaining the idle mode based at least in part on the number of most recent elevator events per a time unit. For example, if the number of most recent elevator events exceeds a specified first threshold, the time period may be adjusted accordingly. Similarly, if the number of most recent elevator events per the time unit exceeds a specified second threshold, the time period may be adjusted again to a different value. The following illustrates a pseudocode example for determining a time period for maintaining the idle mode of the elevator based on starts of the elevator.

```
if(starts_in_last_10min 1= previous_starts_in_last_10min {
  //increase or decrease delay based on start amount
  if/starts_in_last_10min > 10)
    standbydelay = standbydelay + 5s
  if/starts_in_last_10min < 5)
    standbydelay = standbydelay − 1s
  //limit delay
  if(standbydelay < 5s)
    standbydelay = 5s
  if(standbydelay > 45s)
    standbydelay = 55s
}
```

In an example embodiment, determining dynamically a time period for maintaining an idle mode of the elevator based at least in part on the information may comprise determining dynamically the time period for maintaining the idle mode based at least in part on time between the number of most recent elevator events, for example, between recent landing calls or recent elevator runs. The number of most recent elevator events may be set to any appropriate value, for example, 5, 10, 20 or any other value. In other words, when elevator events are identified, the time difference between two subsequent elevator events may be determined, and the time difference associated with the subsequent elevator events may thus be monitored. For example, if the time difference becomes longer, the time period may be dynamically determined to be longer.

In an example embodiment, determining dynamically a time period for maintaining an idle mode of the elevator based at least in part on the information may comprise determining dynamically the time period for maintaining the idle mode based at least in part on a statistical distribution of the elevator events. For example, if the statistical distribution of the elevator events shows that elevator events are identified during a first time period of a day more frequently than during a second time period of the day, the time period may be determined to be longer during the first time period of the day than during the second time period of the day.

In an example embodiment, the controller may be configured to increase the time period in response to an increase in the number of the most recent elevator events per a time unit. In other words, the time period can be adjusted to a greater value as the elevator events happen more often, and thus it is not desirable to configure the elevator to enter the energy saving mode too quickly.

In an example embodiment, the controller may be configured to decrease the time period in response to a decrease in the number of the most recent elevator events per a time unit. In other words, the time period can be adjusted to a lesser value as the elevator events happen less often, and thus the elevator can be configured to enter the energy saving mode to save energy.

In an example embodiment, the controller may be configured to increase the time period in response to a decrease in time between the most recent elevator events. In other words, the time period can be adjusted to a greater value as the elevator events happen more often, and thus it is not desirable to configure the elevator to enter the energy saving mode too quickly.

In an example embodiment, the controller may be configured to decrease the time delay in response to an increase in time between the most recent elevator events. In other words, the time period can be adjusted to a lesser value as the elevator events happen less often, and thus the elevator can be configured to enter the energy saving mode to save energy.

FIG. 2 illustrates a block diagram of a controller 200 according to an example solution. The controller 200 may comprise, for example, an elevator control unit or a control unit of a drive unit of an elevator hoisting motor. The controller 200 may be configured to implement the steps discussed in relation to FIG. 1.

The controller 200 comprises one or more processors 202, and one or more memories 204 that comprise computer program code 206, and/or a communication interface 208 for wired and/or wireless communication. Although the controller 200 is depicted to include only one processor 202, the controller 200 may include more than one processor. In an example embodiment, the memory 204 is capable of storing instructions, such as an operating system and/or various applications.

Furthermore, the processor 202 is capable of executing the stored instructions. In an example embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 202 may be configured to execute hard-coded functionality. In an example embodiment, the processor 202 may be embodied as an executor of software instructions, wherein the instructions may specifically configure the processor 202 to perform the algorithms and/or operations described herein when the instructions are executed, for example, the steps discussed relating to any of FIG. 1. The memory 204 may be embodied as one or more volatile memory devices, one or more non-volatile memory devices, and/or a combination of one or more volatile memory devices and non-volatile memory devices. For example, the memory 204 may be embodied as semiconductor memories (such as mask ROM, PROM (programmable ROM), EPROM (erasable PROM), flash ROM, RAM (random access memory), etc.).

The at least one memory 204 may store program instructions that, when executed by the at least one processor 202, cause the controller 200 to perform the functionality of the various embodiments discussed herein. Further, in an embodiment, at least one of the processor 202 and the memory 204 may constitute means for implementing the discussed functionality. For example, the controller 200 may be configured to obtain a signature associated with the elevator system apparatus, the signature having been generated based at least in part on an elevator system apparatus identifier and metadata at least in part associated with an elevator system part to be installed; obtain the metadata; and verify the signature using an encryption key, the elevator system apparatus identifier and the metadata. A computer program may comprise instructions which, when the program is executed by the at least one processor 202, cause the controller 200 to perform any of the methods described above. Furthermore, a computer-readable medium may comprise the computer program.

FIG. 3 illustrates a block diagram of a control arrangement for controlling an energy saving mode of an elevator according to an example embodiment. The control arrangement comprises a controller 200 discussed above relating to FIGS. 1 and 2, and a power supply switch 300 configured to cut off the power supply of at least one elevator component in response to the request from the controller. In an example embodiment, the power supply switch 300 may be a contactor or a relay. In an example embodiment, elevator may comprise the control arrangement.

One or more of the examples and example embodiments discussed above may enable aa solution for controlling an energy saving mode of an elevator dynamically. In other words, instead of having a fixed time period for entering an energy saving mode from an idle mode, the time period may change and thus adapt to the operation of the elevator. One or more of the examples and example embodiments discussed above may also facilitate optimization of energy consumption in combination with optimization of lifetime of specified elevator components.

The examples discussed above may be implemented in software, hardware, application logic or a combination of software, hardware and application logic. The example devices can store information relating to various methods described herein. This information can be stored in one or more memories, such as a hard disk, a solid state drive (SSD), an optical disk, a magneto-optical disk, an RAM, and the like. One or more databases can store the information used to implement the examples. The databases can be organized using data structures (e.g., records, tables, arrays, fields, graphs, trees, lists, and the like) included in one or more memories or storage devices listed herein. The methods described with respect to the examples can include appropriate data structures for storing data collected and/or generated by the methods of the devices and subsystems of the examples in one or more databases.

The components of the examples may include computer readable medium or memories for holding instructions programmed according to the teachings and for holding data structures, tables, records, and/or other data described herein. In an example, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

While there have been shown and described and pointed out fundamental novel features as applied to preferred examples thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or example may be incorporated in any other disclosed or described or suggested form as a general matter of design choice. Furthermore, in the claims means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. A controller for controlling an energy saving mode of an elevator, the controller comprising:
at least one processor; and
at least one memory storing instructions that, when executed by the at least one processor, cause the controller to at least perform:
obtaining information associated with operating the elevator;
determining dynamically a time period for maintaining an idle mode of the elevator based at least in part on the information; and
issuing a request to switch from the idle mode to the energy saving mode after the time period expires.

2. The controller according to claim 1, wherein the information associated with operating the elevator comprises at least one elevator event, and wherein the at least one memory stores instructions that, when executed by the at least one processor, cause the controller to at least perform:
identifying elevator events; and
issuing the request to switch from the idle mode to the energy saving mode after the time period expires from the last elevator event.

3. The controller according to claim 2, wherein determining dynamically a time period for maintaining an idle mode based at least in part on the information comprises determining dynamically the time period for maintaining the idle mode based at least in part on the number of most recent elevator events per a time unit.

4. The controller according to claim 2, wherein determining dynamically a time period for maintaining an idle mode based at least in part on the information comprises determining dynamically the time period for maintaining the idle mode based at least in part on time between the number of most recent elevator events.

5. The controller according to claim 2, wherein determining dynamically a time period for maintaining an idle mode based at least in part on the information comprises determining dynamically the time period for maintaining the idle mode based at least in part on a statistical distribution of the elevator events.

6. The controller according to claim 2, the at least one memory storing instructions that, when executed by the at least one processor, cause the controller to at least perform:
increasing the time period in response to an increase in the number of the most recent elevator events per a time unit.

7. The controller according to claim 2, the at least one memory storing instructions that, when executed by the at least one processor, cause the controller to at least perform:
decreasing the time period in response to a decrease in the number of the most recent elevator events per a time unit.

8. The controller according to claim 2, the at least one memory storing instructions that, when executed by the at least one processor, cause the controller to at least perform:
increasing the time period in response to a decrease in time between the most recent elevator events.

9. The controller according to claim 2, the at least one memory storing instructions that, when executed by the at least one processor, cause the controller to at least perform:
decreasing the time delay in response to an increase in time between the most recent elevator events.

10. The controller according to claim 2, wherein the elevator event comprises an elevator service request issued via an input device.

11. The controller according to claim 2, wherein the elevator event comprises an elevator run of the elevator.

12. The controller according to claim 1, wherein the information associated with operating the elevator comprises one or more of the following:
a known and/or an expected lifetime of at least one elevator component;
power consumption of the elevator;
a statistical elevator traffic distribution in different times of day; and
a cost of energy for operating the elevator.

13. The controller according to claim 1, wherein the controller is an elevator controller or a control unit of a drive unit of an elevator hoisting motor.

14. A control arrangement for controlling an energy saving mode of an elevator, the control arrangement comprising:
the controller according to claim 1; and
a power supply switch configured to cut off the power supply of at least one elevator component in response to the request from the controller.

15. A method for controlling an energy saving mode of an elevator, the method comprising:
obtaining, by a controller, information associated with operating the elevator;
determining, by the controller, dynamically a time period for maintaining an idle mode based at least in part on the information; and
issuing, by the controller, a request to enter the energy saving mode after the time period expires.

16. A computer program embodied on a non-transitory computer readable medium and comprising instructions which, when the program is executed by at least one processor, cause the least one processor to perform the method of claim 15.

17. The controller according to claim 3, the at least one memory storing instructions that, when executed by the at least one processor, cause the controller to at least perform:
increasing the time period in response to an increase in the number of the most recent elevator events per a time unit.

18. The controller according to claim 4, the at least one memory storing instructions that, when executed by the at least one processor, cause the controller to at least perform:
increasing the time period in response to an increase in the number of the most recent elevator events per a time unit.

19. The controller according to claim 5, the at least one memory storing instructions that, when executed by the at least one processor, cause the controller to at least perform:
increasing the time period in response to an increase in the number of the most recent elevator events per a time unit.

20. The controller according to claim 3, the at least one memory storing instructions that, when executed by the at least one processor, cause the controller to at least perform:
decreasing the time period in response to a decrease in the number of the most recent elevator events per a time unit.
